(19) United States
(12) Patent Application Publication
(10) Pub. No.: US 2026/0065304 A1
(43) Pub. Date: Mar. 5, 2026

(54) GENERATING CUSTOMIZED FOLLOW-UP SURVEY INQUIRIES BASED ON RESPONSE QUALITY IN REAL TIME UTILIZING A MULTIMODAL MODEL

(71) Applicant: Qualtrics, LLC, Provo, UT (US)

(72) Inventors: Emily Geisen, Durham, NC (US); Matt Stevenson, Jesus del Monte (MX); Ricardo Lopez, Ponte Vedra Beach, FL (US); Melissa Kennedy, Mountain Lakes, NJ (US); Zheng Zheng Xing, Bellevue, WA (US); Rajat Agarwal, Kirkland, WA (US); Zayd Hammoudeh, Seattle, WA (US); Recep Colak, Seattle, WA (US)

(21) Appl. No.: 18/824,151

(22) Filed: Sep. 4, 2024

(51) Int. Cl. G06Q 30/0203

(52) U.S. Cl. CPC G06Q 30/0203

(57) ABSTRACT

The present disclosure relates to systems, non-transitory computer-readable media, and methods for generating and customized follow-up survey inquiries in response to digital survey responses. In particular, in one or more embodiments, the disclosed systems receive prompts during survey creation defining goals and/or triggers for follow-up survey inquiries. Further, in some embodiments, the disclosed systems process survey responses utilizing a multimodal model to determine a survey response quality classification and any corresponding triggers in a survey response. Accordingly, the disclosed systems can generate a customized follow-up inquiry based on the survey question, the survey response, and the survey response quality classification.

### BACKGROUND

Recent years have seen significant improvement in software and hardware platforms for collecting and processing digital survey information across computer networks. For example, conventional electronic survey systems can generate digital surveys, distribute digital surveys to various respondent devices, collect digital feedback from the various respondent devices, and process the digital survey response data to generate various survey reporting. Many conventional survey systems collect a large variety of survey response data that varies widely in quality.

Although conventional systems can receive and report survey responses, such systems have a number of problems in relation to accuracy, efficiency, and flexibility of operation. For instance, conventional systems often capture many inaccurate survey responses that are not relevant to the survey response, that are inaccurate, or that are incomplete. Though many conventional systems can determine whether text has been input into a survey response, such text detection cannot address nonsense responses or incomplete responses. Accordingly, many conventional survey systems collect and report such incomplete and nonsense responses that inaccurately assess or reflect survey respondents. Additionally, by failing to address irrelevant or bad response data, the conventional systems also unnecessarily process such data in downstream operations, often resulting in computing systems wasting processing resources and storage capacity on unusable and inaccurate data.

Further, conventional survey systems lack flexibility in survey administration. Though many conventional survey systems can promulgate surveys and receive survey responses, administration of such surveys is often rigid and inflexible, with each survey being administered identically or near-identically. Accordingly, conventional survey systems often fail to elicit survey responses that both meet the goals of the survey administrator and capture accurate information from survey respondents. Additionally, this inflexibility causes many conventional systems to rely on long surveys that target a variety of topics in order to assess all topics that may be relevant to a survey respondent. However, such long surveys often result in the respondent not completing the survey and/or providing short and low-quality responses.

These along with additional problems and issues exist with regard to conventional survey systems.

### BRIEF SUMMARY

Embodiments of the present disclosure provide benefits and/or solve one or more of the foregoing or other problems in the art with systems, non-transitory computer-readable media, and methods for generating customized follow-up survey inquiries for digital surveys based on response quality utilizing a multimodal model. More specifically, in one or more embodiments, the disclosed systems can receive prompts during survey creation that indicate one or more triggers for follow-up questioning. Additionally, in some embodiments, the disclosed systems receive a survey response during administration of a digital survey. Upon receiving the survey response, the disclosed systems can provide a prompt including the survey response to a multimodal model to determine a response quality classification for the survey response. Further, in one or more embodiments, based on the response quality classification and the survey response, the disclosed systems generate customized follow-up survey inquiries.

Additional features and advantages of one or more embodiments of the present disclosure are outlined in the description which follows, and in part will be obvious from the description, or may be learned by the practice of such example embodiments.

### BRIEF DESCRIPTION OF THE DRAWINGS

The detailed description provides one or more embodiments with additional specificity and detail through the use of the accompanying drawings, as briefly described below.

FIG. 1 illustrates a diagram of an environment in which a customized follow-up survey system can operate in accordance with one or more embodiments.

FIG. 2 illustrates an overview of the process of generating a customized follow-up survey inquiry in accordance with one or more embodiments.

FIG. 3 illustrates a process for determining a survey response quality classification and follow-up inquiry trigger classifications in accordance with one or more embodiments.

FIG. 4 illustrates a process for generating a customized follow-up survey inquiry in accordance with one or more embodiments.

FIG. 5 illustrates a survey report graphical user interface in accordance with one or more embodiments.

FIG. 6 illustrates a survey generation graphical user interface in accordance with one or more embodiments.

FIG. 7 illustrates a process for generating a survey report for a survey administered utilizing customized follow-up survey inquiries in accordance with one or more embodiments.

FIG. 8 illustrates a process for training a multimodal model in accordance with one or more embodiments.

FIG. 9 illustrates a flowchart of a series of acts for generating and providing a customized follow-up survey inquiry in accordance with one or more embodiments.

FIG. 10 illustrates a block diagram of an example computing device for implementing one or more embodiments of the present disclosure.

FIG. 11 illustrates a network environment of a digital survey system in accordance with one or more embodiments.

### DETAILED DESCRIPTION

This disclosure describes one or more embodiments of a customized follow-up survey system that generates customized follow-up survey inquiries based on response quality in real-time during administration of a digital survey. To illustrate, the customized follow-up survey system receives administrator input during creation of a digital survey indicating follow-up survey parameters. In one or more embodiments, the customized follow-up survey system then administers the digital survey and receives survey responses. Further, upon receiving a survey response, the customized follow-up survey system can utilize a multimodal model to determine, in real time, a response quality classification for the survey response. In some embodiments, the customized follow-up survey system utilizes the response quality classification to determine whether to generate and provide a customized follow-up survey inquiry. Upon determining that a survey response does trigger a customized follow-up survey inquiry, in one or more embodiments, the customized follow-up survey system generates the customized follow-up survey inquiry based on the survey inquiry, the survey response, and the response quality classification.

As mentioned, in one or more embodiments, the customized follow-up survey system determines parameters for response quality classifications during survey creation. To illustrate, in one or more embodiments, the customized follow-up survey system receives natural language prompts from an administrator device during survey creation defining goals, rules, or other parameters for generating customized follow-up survey inquiries. Further, in some embodiments, the customized follow-up survey system receives parameters for instances to decline to generate follow-up survey inquiries. In one or more embodiments, the customized follow-up survey system utilizes a multimodal model to process and implement these natural language instructions. For example, the customized follow-up survey system can receive and implement goals, completeness standards, and/or sentiment triggers.

Further, in some embodiments, the customized follow-up survey system implements these instructions during administration of the digital survey. To illustrate, in one or more embodiments, the customized follow-up survey system implements administrator parameters by utilizing response quality classifications during administration of the digital survey. In some embodiments, the customized follow-up survey system inputs survey responses into a multimodal model to determine whether the classification triggers, does not trigger, and/or overrides a customized follow-up survey inquiry. For example, a survey trigger classification can include responses failing a completeness requirement, responses mentioning subject matter designated for follow-up, or responses meeting a sentiment score threshold. Additionally, a trigger override classification can include responses with extreme sentiment or responses referring to designated content not to follow-up on.

Additionally, in one or more embodiments, the customized follow-up survey system generates the follow-up survey inquiry based on the initial survey inquiry, the survey response, and the survey response classification. In one or more embodiments, the customized follow-up survey system provides a user-generated follow-up in response to meeting specified parameters. In addition, or in the alternative, the customized follow-up survey system utilizes the multimodal model to generate the customized follow-up survey inquiry. In some embodiments, the customized follow-up survey system also utilizes outputs of a plurality of models as inputs to the multimodal model to improve a decision-making process for providing customized follow-up survey inquiries (e.g., via an ensemble prediction utilizing one or more models to predict sentiment, actionability of a response, etc.).

Upon generating the customized follow-up survey inquiry, the customized follow-up survey system can provide the customized follow-up survey inquiry in real-time within the survey graphical user interface. Accordingly, the customized follow-up survey system can receive a follow-up response to the customized follow-up survey inquiry within the same survey graphical user interface as the other survey questions. Further, in one or more embodiments, the customized follow-up survey system records and organizes survey data from the digital survey including the follow-up survey responses.

Thus, in one or more embodiments, the customized follow-up survey system generates survey reports for digital surveys including data on customized follow-up survey inquiries. Because many such inquiries are bespoke, and accordingly, not uniform, the customized follow-up survey system can aggregate data from similar customized follow-up survey inquiries and summarize the corresponding follow-up responses. For example, the customized follow-up survey system can aggregate customized follow-up survey inquiries corresponding to a particular trigger or having a particular keyword. Thus, the customized follow-up survey system can generate survey reports that accurately and efficiently summarize responses for a survey including a variety of customized follow-up survey inquiries.

The customized follow-up survey system provides many advantages and benefits over conventional systems and methods. For example, by implementing survey administrator parameters for follow-up inquiries utilizing a multimodal model, the customized follow-up survey system improves accuracy relative to conventional systems. Specifically, by utilizing customized follow-up survey inquiries, the customized follow-up survey system can receive accurate responses tailored both to the survey administrator's goals and instructions and the experience of the survey respondent. Further, by utilizing a multimodal model to assess responses, the customized follow-up survey system can identify incomplete responses or low-quality responses. Thus, the customized follow-up survey system can prompt specific correction by generating a customized follow-up survey inquiry. Accordingly, the customized follow-up survey system collects accurate and relevant survey data by intelligently adapting to survey responses in real-time.

The customized follow-up survey system also improves efficiency relative to conventional systems by administering customized follow-up survey inquiries based on survey response data. To illustrate, the customized follow-up survey system reduces or eliminates excessive questioning required by conventional systems by only administering customized follow-up survey inquiries when relevant. Further, the customized follow-up survey system improves efficiency by reducing or eliminating processing and analyzing of poor quality survey data required by conventional systems. More specifically, by determining response quality classifications during survey administration, the customized follow-up survey system improves the quality of collected survey data. Further, in one or more embodiments, the customized follow-up survey system can identify poor quality survey respondents and flag them for exclusion for future surveys, further improving survey data quality and further improving efficiency of data storage, data processing, and network communications, accordingly.

Additionally, the customized follow-up survey system improves flexibility relative to conventional systems by utilizing a multimodal model to customize survey inquiries in real-time. Utilizing the multimodal model to process survey responses and implement administrator parameters allows the customized follow-up survey system to reduce or eliminate excess questioning required by conventional systems to cover all potentially relevant subject matter to a survey respondent. Accordingly, the customized follow-up survey system can collect accurate survey responses specific to respondents while maintaining a streamlined and specific digital survey. Thus, the customized follow-up survey system improves flexibility by adapting in real-time to provide customized follow-up survey inquiries based on administrator parameters and received survey responses.

As illustrated by the foregoing discussion, the present disclosure utilizes a variety of terms to describe features and advantages of the customized follow-up survey system. Additional detail is now provided regarding the meaning of such terms. For example, as used herein, the terms “electronic survey” and “survey” refer to an electronic communication used to collect information. For example, the term survey can include an electronic communication in the form of a poll, questionnaire, census, or other type of sampling. To illustrate, an electronic survey can include an electronic communication that includes one or more electronic survey questions based on information requested by an entity. Further, the term survey as used herein can generally refer to a method of requesting and collecting electronic data from respondents via an electronic communication distribution channel. As used herein, the term “respondent” refers to a person or entity that participates in or responds to a survey. Also, as used herein, the term “administrator” refers to a person or entity that creates or causes the administration of a survey.

Additionally, as used herein, the term “electronic survey question,” “survey question,” or simply “question” refers to a prompt included in a survey to invoke a response from a respondent. For example, a survey question can include one of many different types of questions, including, but not limited to, perception, multiple choice, open-ended, ranking, scoring, summation, demographic, dichotomous, differential, cumulative, dropdown, matrix, net promoter score (NPS), single textbox, heat map, and any other type of prompt that can invoke a response from a respondent. A survey question can include a prompt portion as well as an available answer portion that corresponds to the survey question.

Further, as used herein, the term “response” or “survey response” refers to electronic data a respondent provides with respect to an electronic survey question. The electronic data can include content and/or feedback from the respondent in response to a survey question. Depending on the question type, the response can include, but is not limited to, a selection, a text input, an indication of an answer selection, a user provided answer, a live video, a recorded video, and/or an attachment. In one or more embodiments, some responses do not have a fixed, predetermined structure. For example, an unstructured response can include an open-ended, freeform text response that allows a respondent to input any number of characters (or a threshold number of characters) into a text field in response to a question. In one or more embodiments, a response includes a structured response such as a response from, for example, a set of fixed choices (e.g., multiple choice).

Additionally, as used herein, the term “survey data” refers to information related to an electronic survey. For example, survey data includes data from electronic surveys such as electronic survey questions (e.g., question portions, answer portions), entities associated with the electronic surveys (e.g., survey creators), survey topics/categories or subject matter, and responses to electronic surveys. In addition, as used herein, the term “response data” refers to responses provided by respondent client devices to electronic survey questions. To illustrate, response data includes structured responses and/or unstructured responses.

Additionally, as used herein, the term “multimodal model” refers to a set of one or more machine learning models trained to perform computer tasks to generate or identify computing code and/or data in response to trigger events (e.g., user interactions, such as text queries and button selections). In particular, a multimodal model can include a large language model. In one or more embodiments, the multimodal model can be a neural network (e.g., a deep neural network) with many parameters trained on large quantities of data (e.g., unlabeled text) using a particular learning technique (e.g., self-supervised learning). The multimodal model can receive multimodal data from different mediums such as text, audio, video, image, and other digital content. For example, a multimodal model can include parameters trained to trigger or decline to trigger a customized follow-up survey inquiry. In addition, or in the alternative, a multimodal model can include parameters trained to generate a customized follow-up survey inquiry utilizing a survey response and its corresponding survey inquiry.

Relatedly, as used herein, the term “machine learning model” refers to a computer algorithm or a collection of computer algorithms that automatically improve for a particular task through iterative outputs or predictions based on use of data. For example, a machine learning model can utilize one or more learning techniques to improve in accuracy and/or effectiveness. Example machine learning models include various types of neural networks, decision trees, support vector machines, linear regression models, and Bayesian networks. In some embodiments, the customized follow-up survey system utilizes a large language machine learning model in the form of a neural network.

Along these lines, the term “neural network” refers to a machine learning model that can be trained and/or tuned based on inputs to generate digital content such as text and images, and to determine classifications, scores, or approximate unknown functions. For example, a neural network includes a model of interconnected artificial neurons (e.g., organized in layers) that communicate and learn to approximate complex functions and generate outputs (e.g., information flow patterns) based on a plurality of inputs provided to the neural network. In some cases, a neural network refers to an algorithm (or set of algorithms) that implements deep learning techniques to model high-level abstractions in data. A neural network can include various layers such as an input layer, one or more hidden layers, and an output layer that each perform tasks for processing data. For example, a neural network can include a deep neural network, a convolutional neural network, a recurrent neural network (e.g., an LSTM), a graph neural network, a transformer neural network, a diffusion neural network, a generative adversarial neural network, or a large language model.

Further, as used herein, the term “response quality classification” refers to a categorization for a digital survey response. In particular, the term response quality classification can include a classification to trigger a customized follow-up survey inquiry, a classification not to trigger a customized follow-up survey inquiry, and/or a classification to override a customized follow-up survey inquiry. For example, a survey response quality classification can include classifications based on subject matter, actionability, emotion, sentiment, and/or completeness.

Additionally, as used herein, the term “customized follow-up survey inquiry” refers to a survey inquiry provided in real-time and generated based on a survey response. In particular, the term customized follow-up survey inquiry can include a bespoke prompt generated for a specific instance of a survey based on a particular survey response, its corresponding survey question, survey respondent data, and a response quality classification. For example, a customized follow-up survey inquiry can include a question generated by a multimodal model and provided in a survey graphical user interface in response to a survey response. The customized follow-up survey inquiry can include a free response survey inquiry, a multiple choice survey inquiry, a matrix of survey inquiries, or a video survey inquiry.

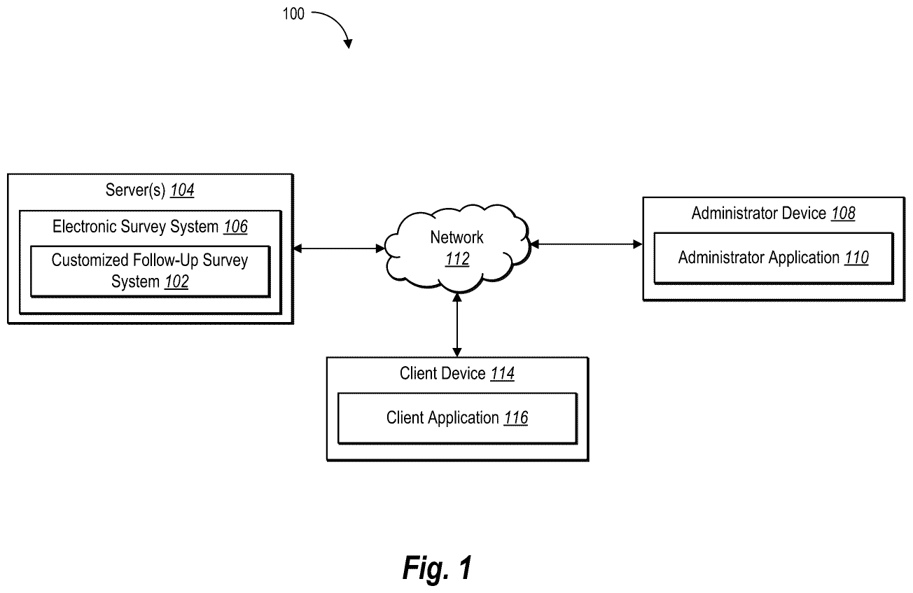

Additional detail will now be provided in relation to illustrative figures portraying example embodiments and implementations of the persona group system. For example, FIG. 1 illustrates a schematic diagram of an example system environment 100 for implementing a customized follow-up survey system 102 in accordance with one or more implementations. An overview of the customized follow-up survey system 102 is described in relation to FIG. 1. Thereafter, a more detailed description of the components and processes of the customized follow-up survey system 102 is provided in relation to the subsequent figures.

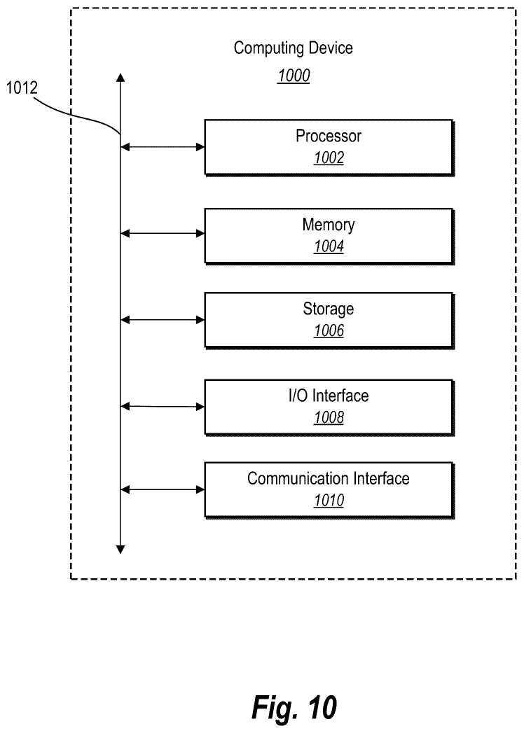

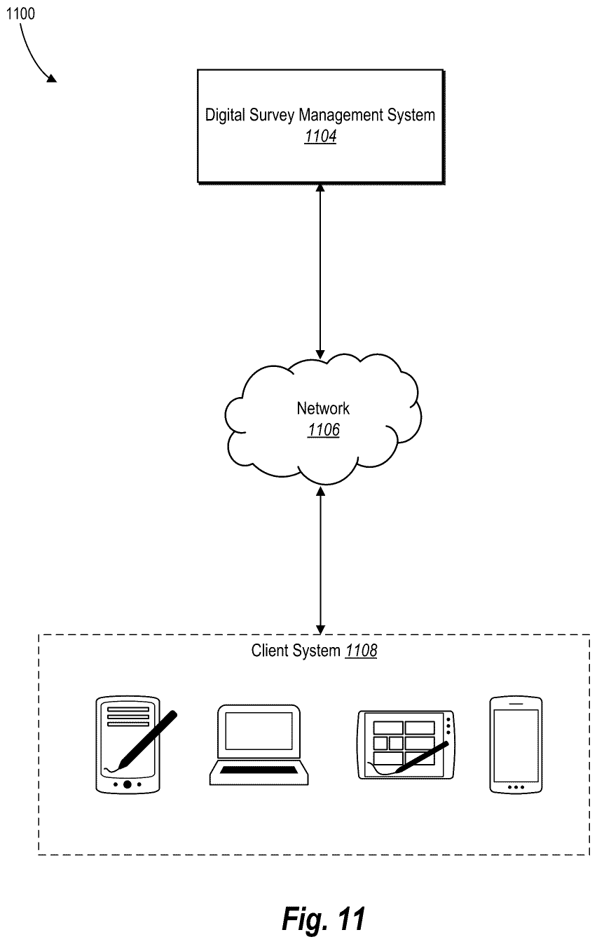

As shown, the environment 100 includes server(s) 104, an administrator device 108, a client device 114, and a network 112. Each of the components of the environment 100 can communicate via the network 112, and the network 112 may be any suitable network over which computing devices can communicate. Example networks are discussed in more detail below in relation to FIGS. 10-11.

As illustrated in FIG. 1, the example environment 100 also includes the server(s) 104. The server(s) 104 may generate, track, store, process, receive, and transmit electronic data, such as digital surveys, digital survey data, survey parameters, survey reports, and/or interactions between administrator devices and client devices. For example, the server(s) 104 may receive data from the client device 114 (e.g., a respondent client device) in the form of a survey response. In addition, the server(s) 104 can transmit data to the client device 114 in the form of a customized follow-up survey inquiry, notifications, additional surveys, or other prompts. Indeed, the server(s) 104 can communicate with the client device 114 to send and/or receive data via the network 112. In one or more embodiments, the server(s) 104 can also include a multimodal model that is native to, housed or hosted on, and/or maintained by the electronic survey system 106. In some implementations, the server(s) 104 comprise(s) a distributed server where the server(s) 104 include(s) a number of server devices distributed across the network 112 and located in different physical locations. The server(s) 104 can comprise one or more content servers, application servers, communication servers, web-hosting servers, machine learning servers, and other types of servers. In addition, in one or more embodiments, the multimodal model may be hosted elsewhere, including on a client device (e.g., the administrator device 108, the client device 114) or a third-party server.

In one or more embodiments, the electronic survey system 106 comprises computer executable instructions that, when executed by a processor of the server(s) 104, perform actions to coordinate with the administrator device 108 and/or the client device 114 to administer electronic surveys. For example, the electronic survey system 106 communicates with the administrator device 108 via the network 112 to administer electronic surveys to the client device 114. Additionally, the electronic survey system 106 communicates with the client device 114 via the network 112 to obtain response data and/or other survey data in connection with the administered electronic surveys. Additionally, the electronic survey system 106 can communicate with the client device 114 to obtain one or more portions of survey data associated with an electronic survey. Further, the electronic survey system 106 can receive data from the administrator device 108 and/or one or more third-party devices. Specifically, in one or more embodiments, the electronic survey system 106 receives user data for survey respondents from administrator device 108 and/or one or more third-party devices.

As mentioned above, the example environment 100 includes an administrator device 108. The administrator device 108 can be one of a variety of computing devices, including a smartphone, a tablet, a smart television, a desktop computer, a laptop computer, a virtual reality device, an augmented reality device, or another computing device as described in relation to FIGS. 10-11. The administrator device 108 can communicate with the server(s) 104 or the client device 114 via the network 112. For example, the administrator device 108 can receive user input from a user interacting with the client device 114 (e.g., via the administrator application 110) to, for instance, generate or monitor a digital survey. In addition, the customized follow-up survey system 102 on the server(s) 104 can receive information relating to various interactions with digital surveys based on the input received by administrator device 108.

As shown, the administrator device 108 can include an administrator application 110. In particular, the administrator application 110 may be a web application, a native application installed on the administrator device 108 (e.g., a mobile application, a desktop application, etc.), or a cloud-based application where all or part of the functionality is performed by the server(s) 104. Based on instructions from the administrator application 110, the administrator device 108 can present or display information, including survey inquiries, survey parameters, survey responses, and/or survey reports.

Additionally, the example environment 100 includes a client device 114. In one or more embodiments, the client device 114 is a respondent device. The client device 114 can be one of a variety of computing devices, including a smartphone, a tablet, a smart television, a desktop computer, a laptop computer, a virtual reality device, an augmented reality device, or another computing device as described in relation to FIGS. 10-11. The client device 114 can communicate with the server(s) 104 via the network 112. For example, the client device 114 can receive user input from a user interacting with the client device 114 (e.g., via the client application 116) to, for instance, access or provide responses to a digital survey. In addition, the customized follow-up survey system 102 on the server(s) 104 can receive information relating to various interactions with digital surveys based on the input received by the client device 114.

As shown, the client device 114 can include a client application 116. In particular, the client application 116 may be a web application, a native application installed on the client device 114 (e.g., a mobile application, a desktop application, etc.), or a cloud-based application where all or part of the functionality is performed by the server(s) 104. Based on instructions from the client application 116, the client device 114 can present or display information, including digital surveys and/or customized follow-up survey inquiries.

Although FIG. 1 depicts the customized follow-up survey system 102 located on the server(s) 104, in some implementations, the customized follow-up survey system 102 may be implemented by (e.g., located entirely or in part on) one or more other components of the environment 100. For example, the customized follow-up survey system 102 may be implemented by the administrator device 108, the client device 114 and/or a third-party device. For example, the administrator device 108 can download all or part of the customized follow-up survey system 102 for implementation independent of, or together with, the server(s) 104.

In some implementations, though not illustrated in FIG. 1, the environment 100 may have a different arrangement of components and/or may have a different number or set of components altogether. For example, the administrator device 108 and the client device 114 may communicate directly with the customized follow-up survey system 102, bypassing the network 112. As another example, the environment 100 can include a database located external to the server(s) 104 (e.g., in communication via the network 112) or located on the server(s) 104, on a third-party system, and/or on the administrator device 108 or on the client device 114.

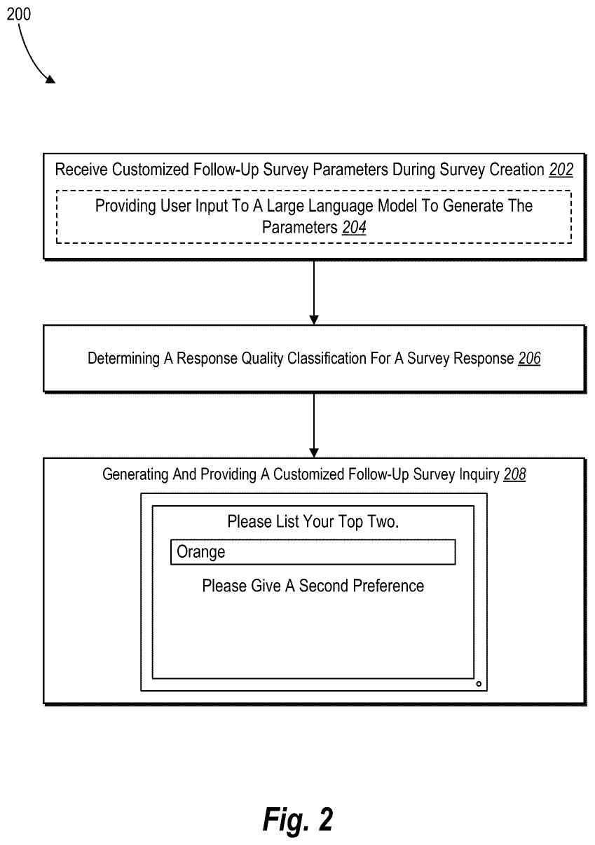

As discussed above, the customized follow-up survey system 102 can generate customized follow-up survey inquiries using response quality information from real-time response data. Further, the customized follow-up survey system 102 can provide the customized follow-up survey inquiries in real-time via a survey graphical user interface. For instance, FIG. 2 illustrates an overview for a process 200 of generating and providing customized follow-up survey inquiries in accordance with one or more embodiments.

Specifically, as shown in FIG. 2, the customized follow-up survey system 102 performs an act 202 of receiving customized follow-up survey parameters during survey creation. To illustrate, in one or more embodiments, the customized follow-up survey system 102 receives user input indicating a custom digital survey. The customized follow-up survey system 102 can receive user input indicating survey inquiries, survey answer formats, and other survey parameters. Further, during creation of a digital survey, the customized follow-up survey system 102 can receive user input indicating parameters for customized follow-up survey inquiries.

More specifically, in one or more embodiments, the customized follow-up survey system 102 receives user input indicating when the customized follow-up survey system 102 should generate and provide a customized follow-up survey inquiry. Further, in some embodiments, the customized follow-up survey system 102 can receive user input indicating when the customized follow-up survey system 102 should override one or more triggers and decline to generate and provide a customized follow-up survey inquiry. In one or more embodiments, the customized follow-up survey system 102 can receive the customized follow-up survey parameters as natural language input from an administrator device.

Accordingly, as shown in FIG. 2, in one or more embodiments, the customized follow-up survey system 102 performs an optional act 204 of providing the user input to a multimodal model to generate the customized follow-up survey parameters. In some embodiments, the customized follow-up survey system 102 utilizes the received user input as instructions for a multimodal model. In addition, or in the alternative, the customized follow-up survey system 102 can train the multimodal model utilizing ground truth data based on the provided parameters.

As also shown in FIG. 2, the customized follow-up survey system 102 performs an act 206 of determining a response quality classification for a survey response. In some embodiments, the customized follow-up survey system 102 receives survey response data for a survey response during administration of a digital survey. In one or more embodiments, the customized follow-up survey system 102 can determine response quality classifications by generating and providing a prompt including the survey response data to the multimodal model that was provided follow-up survey parameters during survey creation.

In one or more embodiments, response quality classifications include survey trigger classifications that indicate that the customized follow-up survey system 102 should generate a customized follow-up survey inquiry and non-trigger classifications that indicate that the survey response data does not trigger a follow-up survey inquiry. In one or more embodiments, response quality classifications also include an excluded category classifications that indicate that the customized follow-up survey inquiry should not generate a customized follow-up survey inquiry regardless of other classifications.

Further, as shown in FIG. 2, the customized follow-up survey system 102 can perform an act 208 of generating and providing a customized follow-up survey inquiry. As shown in FIG. 2, the customized follow-up survey system 102 can provide the customized follow-up survey inquiry in a survey graphical user interface. For example, as shown in FIG. 2, the customized follow-up survey system 102 receives a survey response “Orange” to a survey inquiry “Please List Your Top Two.” Based on determining that the survey response data reflects an incomplete response survey trigger classification, the customized follow-up survey system 102 provides the customized follow-up survey inquiry “Please Give A Second Preference.”

In one or more embodiments, the customized follow-up survey system 102 generates the customized follow-up survey inquiry by providing the survey data to the multimodal model that was provided follow-up survey parameters during survey creation and receiving the customized follow-up survey inquiry as output. In addition, or in the alternative, the customized follow-up survey inquiry can receive the response quality classification from the multimodal model and provide a predetermined customized follow-up survey inquiry based on the response quality classification.

Further, as shown in FIG. 2, the customized follow-up survey system 102 can provide the customized follow-up survey inquiry in real-time. Additionally, the customized follow-up survey system 102 can provide the customized follow-up survey inquiry in the survey graphical user interface alongside other survey inquiries. Accordingly, the customized follow-up survey system 102 can receive follow-up information, correct incomplete responses, prompt information related to responses, and collect other additional survey data in real-time during administration of the digital survey.

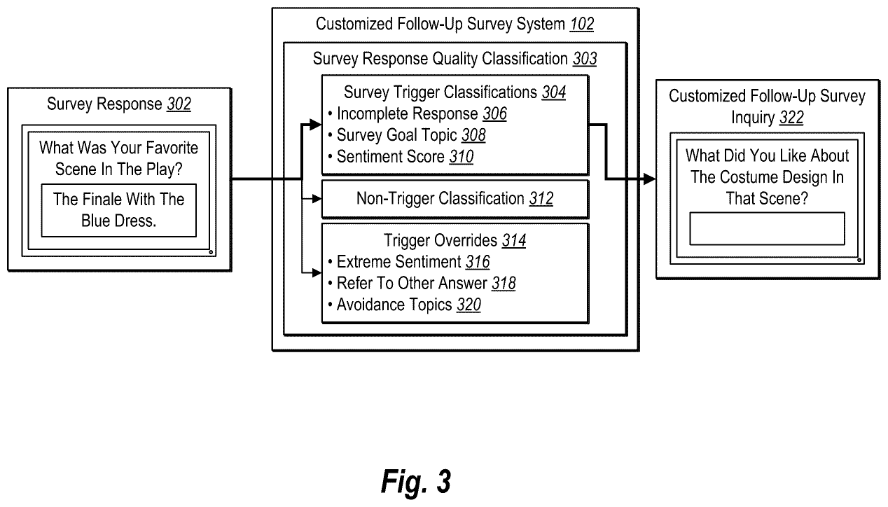

As discussed above, in one or more embodiments, the customized follow-up survey system 102 determines survey response quality classifications corresponding to survey response data. FIG. 3 illustrates additional detail regarding generating and utilizing survey response quality classifications. As shown in FIG. 3, the customized follow-up survey system 102 receives a survey response 302. More specifically, the customized follow-up survey system 102 receives the survey response 302 “The Finale With The Blue Dress” to the survey inquiry “What Was Your Favorite Scene In The Play?” In one or more embodiments, the survey response 302 includes survey response data indicating the substance of a survey response, such as free response text provided via a respondent device. Further, in some embodiments, the survey response 302 includes related data such as timestamps, user data, location data, user response data, and other embedded data.

Further, in one or more embodiments, the customized follow-up survey system 102 can utilize particular portions of embedded data based on administrator follow-up survey parameters received during survey creation. For example, in one or more embodiments, the customized follow-up survey system 102 can receive user input selecting user data and location data for determining survey response quality classifications and/or generating customized follow-up survey inquiries. Based on this survey follow-up parameter, the customized follow-up survey system 102 can extract the indicated embedded data and provide the indicated embedded data to the multimodal model for determining survey response quality classifications and/or generating customized follow-up survey inquiries.

For example, the customized follow-up survey system 102 can utilize user data reflecting user settings, prior user selections, user demographic information, user loyalty status, and other user preferences. Indeed, in one or more embodiments, the customized follow-up survey system 102 extracts and utilizes this user data with the multimodal model to determine the customized follow-up survey inquiries. In one or more embodiments, the customized follow-up survey system 102 receives this user data from a third-party system associated with the digital survey. Accordingly, the customized follow-up survey system 102 can determine customized follow-up survey inquiries based on a variety of user data to better tailor responses to a particular recipient.

Additionally, in one or more embodiments, the customized follow-up survey system 102 utilizes user data reflecting previous survey responses. Accordingly, in one or more embodiments, the customized follow-up survey system 102 can implement digital survey parameters consistently and informed by prior user interactions. For example, the customized follow-up survey system 102 can utilize the survey response data to implement a survey parameter to never repeat survey inquiries that have already been answered, including from prior digital surveys.

As shown in FIG. 3, the customized follow-up survey system 102 generates survey response quality classifications 303 based on the survey response 302. The survey response quality classifications 303 can include one or more of survey trigger classifications 304 that trigger a customized follow-up survey inquiry (e.g., by causing the customized follow-up survey system to execute, or generate instructions for another system to execute, the customized follow-up survey inquiry), a non-trigger classification 312 that does not indicate a survey trigger, and trigger override classifications 314 that indicate exclusion from consideration for a customized follow-up survey inquiry. As shown in FIG. 3, the customized follow-up survey system 102 determines survey trigger classifications 304 for the survey response 302 to generate a customized follow-up survey inquiry 322.

In one or more embodiments, the customized follow-up survey system 102 automatically detects a language from the survey response 302. In some embodiments, the customized follow-up survey system 102 utilizes a multimodal model to determine the language corresponding to the survey response 302, and then determines the survey response quality classifications 303 and provides the customized follow-up survey inquiry 322 utilizing that language. In addition, or in the alternative, the customized follow-up survey system 102 can determine language utilizing a different model and then provide the survey response 302 to a multimodal model corresponding to the determined language.

In one or more embodiments, the customized follow-up survey system 102 determines the survey response quality classifications 303 utilizing the survey response 302 and a multimodal model. In some embodiments, the customized follow-up survey system 102 receives the survey response quality classifications 303 from the multimodal model. In addition, or in the alternative, the customized follow-up survey system 102 can receive a customized follow-up survey inquiry 322 from the multimodal model. To illustrate, in one or more embodiments, the customized follow-up survey system 102 can generate one or both of the survey response quality classifications 303 and the customized follow-up survey inquiry 322.

In some embodiments, the customized follow-up survey system 102 determines the survey response trigger classification 303 upon submission of the survey response 302. In addition, or in the alternative, the customized follow-up survey system 102 can determine the survey response trigger classification 303 in response to detecting that the survey respondent has concluded writing the response survey response. Further, the customized follow-up survey system 102 can determine the survey response trigger classification 303 or in-situ as the survey respondent is drafting the survey response. In such an implementation, the customized follow-up survey system 102 can provide customized follow-up survey inquiries in real-time as a form of “real-time coaching” or “real-time assistance” to assist in completion of the survey response.

Further, in one or more embodiments, the customized follow-up survey system 102 provides a prompt including survey response data to a multimodal model to receive a follow-up score. In one or more embodiments, the customized follow-up survey system 102 utilizes the follow-up score to generate a response quality classification for the survey response. More specifically, in one or more embodiments, the customized follow-up survey system 102 compares the follow-up score to a follow-up threshold to determine either a survey trigger classification or a non-trigger classification for the survey response. In addition, or in the alternative, the customized follow-up survey system 102 can utilize the follow-up score to determine a number of triggers indicated by the survey response data and/or a degree to which the survey response data indicates the triggers.

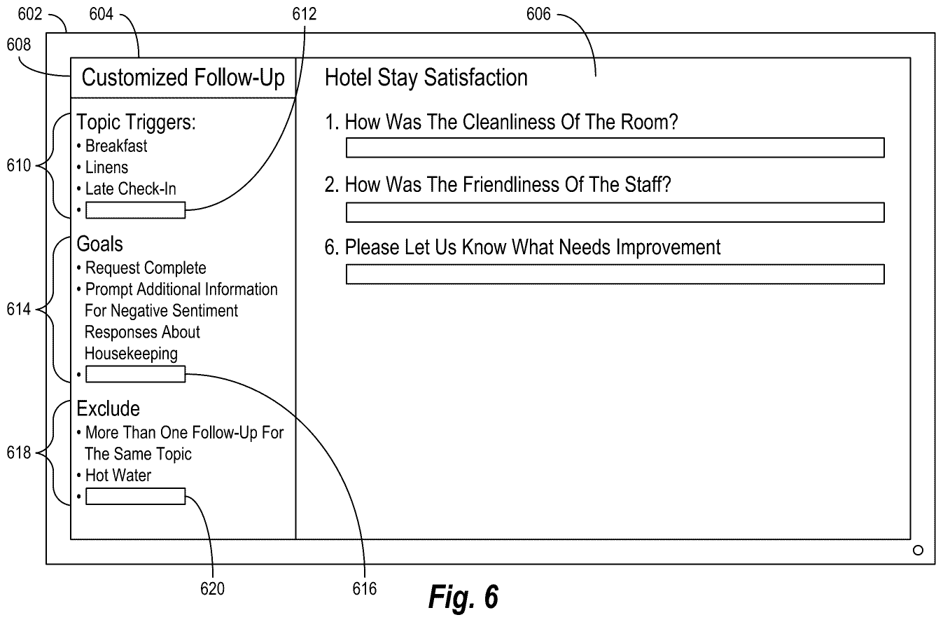

As will be discussed in greater detail below with regard to FIG. 6, in one or more embodiments, the customized follow-up survey system 102 utilizes a multimodal model trained or instructed based on parameters provided during survey creation. To illustrate, in one or more embodiments, the survey response quality classifications 303 are defined based on parameters provided to the customized follow-up survey system 102 during survey creation. For example, in one or more embodiments, the customized follow-up survey system 102 provides natural language instructions defining the survey trigger classifications 304, the non-trigger classification 312, and the trigger override classifications 314.

As shown in FIG. 3, the survey trigger classifications 304 include an incomplete response classification 306, a survey goal subject matter classification 308, and a sentiment score classification 310. In one or more embodiments, the incomplete response classification 306 includes survey responses that do not fully address or answer the survey inquiry. For example, the customized follow-up survey system 102 can apply the incomplete response classification 306 to a survey response that only answers one part of a two-part question, a survey response that provides fewer points than prompted, and/or a survey response that is nonsensical (e.g., a partial phrase or sentence).

In one or more embodiments, the customized follow-up survey system 102 can further assign the incomplete survey response classification 306 to “fraudulent” or auto-generated spam responses. In one or more embodiments, the customized follow-up survey system 102 can automatically remove survey responses with the incomplete response classification 306 from analysis in order to remove low-quality data. Further, the customized follow-up survey system 102 can exclude a survey response from incentive programs based on assigning it the incomplete response classification 306. Accordingly, the customized follow-up survey system 102 can disincentivize low-quality survey responses.

Further, as shown in FIG. 3, the survey trigger classifications 304 include a survey goal subject matter classification 308. In one or more embodiments, the customized follow-up survey system 102 receives one or more designations of subject matter during survey creation designated for customized follow-up survey inquiry prompting additional details. Accordingly, the customized follow-up survey system 102 can designate a survey goal subject matter classification 308 corresponding to this “goal” subject matter for additional questioning. In one or more embodiments, the customized follow-up survey system 102 utilizes the multimodal model to identify subject matter from survey responses for the survey goal subject matter classification 308. In an example where costuming is goal subject matter for a digital survey, the customized follow-up survey system 102 can determine that the survey response 302 includes mention of a “blue dress,” and thus relates to costuming, and consequently assign it the survey goal subject matter classification 308.

Further, in some embodiments, the customized follow-up survey system 102 can implement a survey goal trigger related to an uncommon or new survey response topic. For example, the customized follow-up survey system 102 can receive a designation to prompt additional information about new subject matter during survey creation. Accordingly, the customized follow-up survey system 102 can utilize the multimodal model to determine that a survey response includes a topic that is not typically referenced or has not been referenced before, and accordingly belongs to a survey goal subject matter classification. Based on this classification, the customized follow-up survey system 102 can ask one or more customized follow-up survey inquiries to get additional information about the new or uncommon topic.

Additionally, in one or more embodiments, the survey trigger classifications 304 include a sentiment score classification 310. In some embodiments, the customized follow-up survey system 102 can implement survey follow-up parameters related to survey response sentiment. In particular, the customized follow-up survey system 102 can implement a survey trigger classification for sentiment range(s) indicated during survey creation. For example, the customized follow-up survey system 102 can utilize a multimodal model to determine a sentiment score for a survey response and whether that sentiment score falls within a designated range.

Additionally, in one or more embodiments, a sentiment score classification 310 can also include classifications based on an emotion categorization. To illustrate, the customized follow-up survey system 102 can utilize the multimodal model to determine one or more emotions for a survey response. Accordingly, the customized follow-up survey system 102 can implement survey parameters indicating to generate or not to generate customized follow-up survey inquiries based on particular emotions. For example, the customized follow-up survey system 102 can implement a parameter indicating a customized follow-up survey inquiry asking what can be improved in response to a survey response indicating sadness. In another example, the customized follow-up survey system 102 can implement a parameter indicating that no further customized follow-up survey inquiries should be generated if a survey response indicates anger.

Further, the customized follow-up survey system 102 can implement survey follow-up parameters that involve the intersection of one or more survey trigger classifications 304. For example, the customized follow-up survey system 102 can generate a customized follow-up survey inquiry in response to determining that a survey inquiry includes positive sentiment about a particular person or determining that there is an incomplete response corresponding to a goal topic. Accordingly, the customized follow-up survey system 102 can utilize a multimodal model to identify and respond to multiple and intersecting survey follow-up parameters.

Additionally, in one or more embodiments, the customized follow-up survey system 102 can utilize and assign a non-trigger classification 312. In some embodiments, the customized follow-up survey system 102 automatically applies a non-trigger classification to any survey response that does not have any survey trigger classifications 304. In one or more embodiments, the customized follow-up survey system 102 utilizes a multimodal model to process survey responses to identify those with the non-trigger classification 312. As shown in FIG. 3, since the survey response 302 has a survey response quality classification, the survey response 302 is not placed in the non-trigger classification 312.

Further, as shown in FIG. 3, the customized follow-up survey system 102 can utilize a trigger override classifications 314. In one or more embodiments, the trigger override classifications 314 include one or more classifications for which to decline a customized follow-up survey inquiry regardless of any other survey response quality classifications 303. As shown in FIG. 3, the trigger override classifications 314 can include an extreme sentiment classification 316, a refer to other answer classification 318, and an avoidance topic classification 320.

As just mentioned, the trigger override classifications 314 can include an extreme sentiment classification 316. In one or more embodiments, the customized follow-up survey system 102 can implement survey follow-up parameters designating one or more sentiment score ranges for exclusion from consideration for a customized follow-up survey inquiry. Similar to discussion above with regard to sentiment scoring, in one or more embodiments, the customized follow-up survey system 102 utilizes a multimodal model to determine a sentiment score for a survey response and whether that sentiment score falls within a designated range for the extreme sentiment classification 316. For example, the customized follow-up survey system 102 can utilize a multimodal model to determine that a survey response includes extreme negative sentiment and, accordingly, apply the extreme sentiment classification 316. In another example, the customized follow-up survey system 102 can also implement trigger override classifications 314 for a variety of sentiment score ranges, including moderate or neutral sentiments.

Further, as shown in FIG. 3, the trigger override classifications 314 can include a refer to other answer classification 318. In one or more embodiments, the customized follow-up survey system 102 can utilize a multimodal model to identify survey responses that refer to other survey responses. Accordingly, the customized follow-up survey system 102 can apply the refer to other answer classification 318 and automatically decline to generate a customized follow-up survey inquiry for the corresponding survey response.

As also shown in FIG. 3, the trigger override classifications 314 can include an avoidance topic classification 320. In one or more embodiments, the customized follow-up survey system 102 can implement follow-up survey parameters that indicate one or more categories for exclusion from consideration for a customized follow-up survey inquiry. For example, the customized follow-up survey system 102 can utilize a multimodal model to automatically decline to generate a customized follow-up survey inquiry for sensitive categories, known issues, categories that are not of interest to the survey administrators, or a variety of other categories specified by follow-up survey parameters given during survey creation. Additionally, in one or more embodiments, the trigger override classifications 314 can include survey inquiries that are already present in a digital survey. Accordingly, the customized follow-up survey system 102 can ensure not to provide a customized follow-up survey inquiry that is too similar to an inquiry that will be provided later in the digital survey.

Further, in some embodiments, the customized follow-up survey system 102 can determine an actionability rating for survey responses. More specifically, the customized follow-up survey system 102 can receive and implement survey parameters indicating what items are solvable by the administrator and which are not. Accordingly, the customized follow-up survey system 102 can decline to generate and provide customized follow-up survey inquiries for items that are not actionable by the administrator and corresponding entities. In one or more embodiments, the customized follow-up survey system 102 can designate goal topics as actionable and avoidance topics as not actionable. For example, the customized follow-up survey system 102 can receive a survey parameter indicating that airport conditions are not actionable. Accordingly, the customized follow-up survey system 102 can add airport conditions to the avoidance topic classification 320. Accordingly, the customized follow-up survey system 102 can decline to generate a customized follow-up survey inquiry about airport smell based on the avoidance topic classification 320, even if the survey response also has a survey trigger classification.

As noted above, in some embodiments, the customized follow-up survey system 102 utilizes ensemble predictions to determine whether to provide customized follow-up inquiries. For example, in one or more embodiments, the customized follow-up survey system 102 utilizes one or more neural networks to generate one or more sentiment predictions for a response and one or more additional neural networks to generate actionability predictions for the response. Additionally, the customized follow-up survey system provides the predictions to a multimodal model to generate the final determination of whether to provide a customized follow-up inquiry. Thus, the customized follow-up survey system 102 can use a multi-stage model that includes a first stage of one or more neural networks to generate initial predictions for one or more attributes of a response and a second stage to make a final determination based on the output of the first stage.

As shown in FIG. 3, based on determining that the survey response 302 has one or more survey trigger classifications 304 and no trigger override classifications 314, the customized follow-up survey system 102 generates the customized follow-up survey system 102. More specifically, based on determining that the survey response 302 qualifies for the survey goal subject matter classification 308 corresponding to survey goal subject matter of costume design, the customized follow-up survey system 102 generates the customized follow-up survey inquiry 322 to prompt additional information related to costume design. As shown in FIG. 3, the customized follow-up survey system 102 reads “What did you like about the costume design in that scene?” Accordingly, the customized follow-up survey system 102 can collect additional information about costume design from a survey respondent that has already mentioned noticing costuming.

In one or more embodiments, the customized follow-up survey system 102 generates customized follow-up survey inquiries utilizing a multimodal model. As mentioned above, in one or more embodiments, the customized follow-up survey system 102 trains or instructs a multimodal model utilizing survey follow-up parameters received during survey creation. In one or more embodiments, the customized follow-up survey system 102 provides the survey response data corresponding to the survey response 302 and the corresponding survey inquiry to this multimodal model to generate the customized follow-up survey inquiry 322.

In addition, or in the alternative, the customized follow-up survey system 102 can implement survey parameters prescribing administrator-generated customized follow-up survey inquiries. More specifically, the customized follow-up survey system 102 can implement survey parameters that indicate a particular survey inquiry for presentation based on the survey to one or more survey trigger classifications. In such an example, the customized follow-up survey system 102 can utilize a multimodal model to determine the survey response quality classifications 303 corresponding to the survey response. Upon receiving the survey response quality classifications 303 from the multimodal model, the customized follow-up survey system 102 can automatically provide the prescribed follow-up survey inquiry. In one or more embodiments, the customized follow-up survey system 102 customizes the administrator-generated inquiry based on the survey response for which it was triggered.

For example, the customized follow-up survey system 102 can implement a survey parameter requiring presentation of the survey inquiry “Please indicate what was wrong with [damaged item].” in response to a survey inquiry mentioning a damaged item. To illustrate, the customized follow-up survey system 102 can utilize the multimodal model to determine which item was indicated as damaged in the survey response. Accordingly, the customized follow-up survey system 102 can integrate the relevant information to generate and provide the customized follow-up survey inquiry “Please indicate what was wrong with the blue plastic bowls.” based on the administrator-generated survey inquiry.

Further, in one or more embodiments, the customized follow-up survey system 102 can receive and implement instructions to provide a chain of customized follow-up survey inquiries. To illustrate, the customized follow-up survey system 102 can receive and implement survey follow-up parameters that indicate additional customized follow-up survey inquiries to provide in response to survey responses to customized follow-up survey inquiries. For example, the customized follow-up survey system 102 can implement a follow-up survey parameter that specifies a customized follow-up survey inquiry asking how long it took the respondent to park if the survey response mentions parking. The customized follow-up survey system 102 can further implement a follow-up survey parameter that specifies an additional customized follow-up survey inquiry asking where the respondent parked if the follow-up response indicates a time longer than ten minutes.

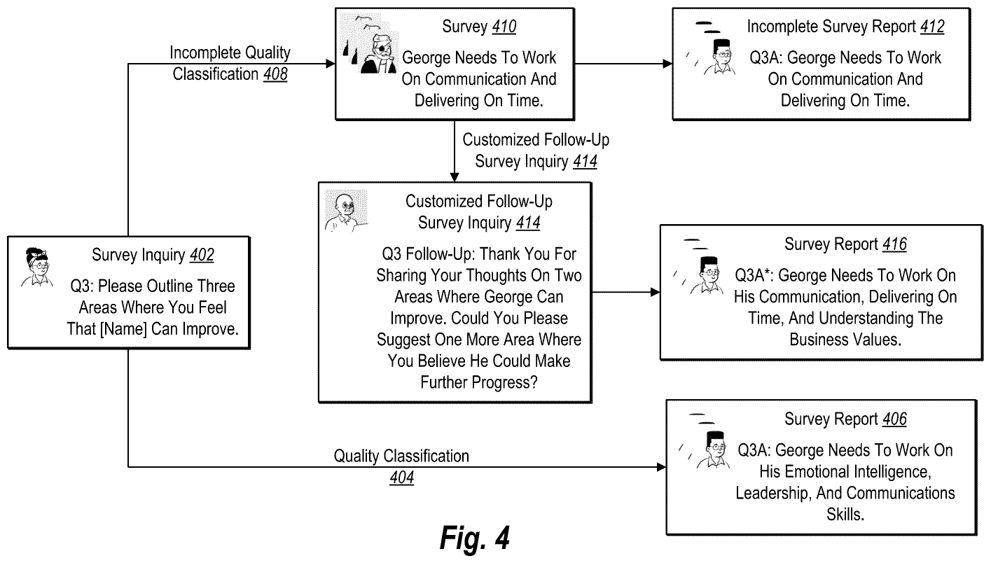

As mentioned above, the customized follow-up survey system 102 can provide customized follow-up survey inquiries in real-time and categorize and report corresponding survey responses. FIG. 4 provides an example implementation of the customized follow-up survey system 102 generating a customized follow-up survey inquiry in real-time and utilizing the corresponding responses to generate survey reports. To illustrate, as shown in FIG. 4, the customized follow-up survey system 102 provides a survey inquiry 402 to various respondent devices. The survey inquiry 402 reads “Q3: Please outline three areas where you feel that [Name] can improve.” The customized follow-up survey system 102 can provide the survey inquiry 402 with appropriate names inserted corresponding to the respondent device.

The customized follow-up survey system 102 declines to generate customized follow-up survey inquiries for survey responses with no survey trigger classifications. Thus, as shown in FIG. 4, the customized follow-up survey system 102 determines that a survey response has a good quality classification 404 and provides these survey responses to a survey report 406. For example, as shown in FIG. 4, the survey response “George needs to work on his emotional intelligence, leadership, and communication skills” received the good quality classification 404 because it is a complete answer.

However, for survey responses with a survey trigger classification, the customized follow-up survey system 102 generates a customized follow-up survey inquiry in order to avoid an incomplete survey report. To illustrate, as shown in FIG. 4, the customized follow-up survey system 102 can determine an incomplete survey classification for the survey response 410, which reads “George needs to work on communication and delivering on time.” Since this response is incomplete, inaction would result in an incomplete survey report 412, as it would lack the third requested area that George can improve.

Accordingly, the customized follow-up survey system 102 generates a customized follow-up survey inquiry 414 based on determining that the survey response 410 qualifies for the incomplete quality classification 408. More specifically, the customized follow-up survey system 102 generates the customized follow-up survey inquiry 414 to prompt the respondent to provide an additional area for improvement. As shown in FIG. 4, the customized follow-up survey inquiry 414 reads “Thank you for sharing your thoughts on two areas where George can improve. Can you please suggest one more area where you believe he could make further progress?”

In response to this, the customized follow-up survey system 102 receives a follow-up survey response (e.g., an additional comment including one more area where George can improve). Further, in one or more embodiments, the customized follow-up survey system 102 combines the survey response 410 and the survey response to the customized follow-up survey inquiry 414. Thus, the customized follow-up survey system 102 generates the survey report 416 to read “George needs to work on his communication, delivering on time, and understanding the business values.” Thus, the customized follow-up survey system 102 can provide the aggregated response as a single complete response alongside other complete responses to the same survey inquiry.

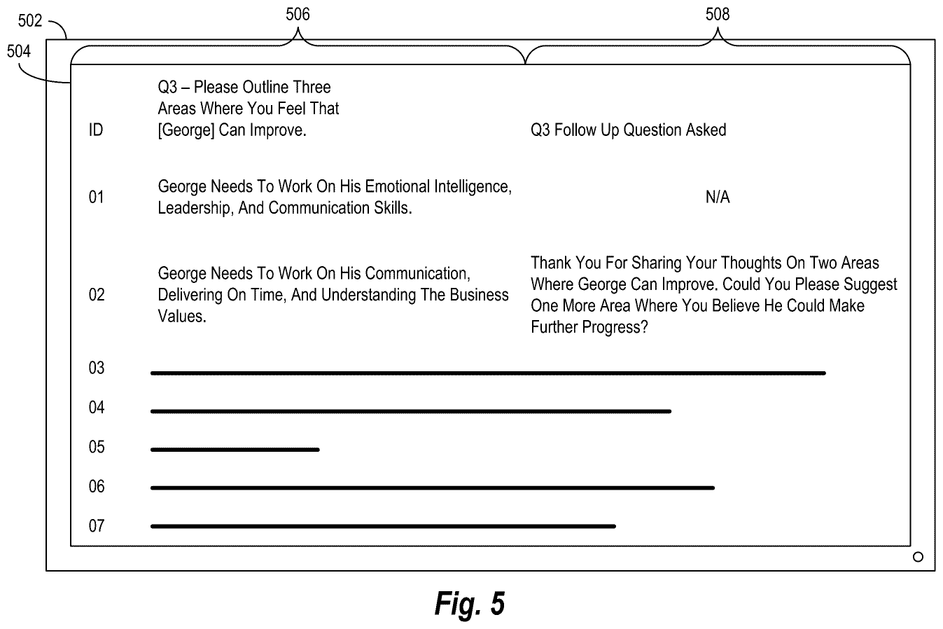

Additionally, in one or more embodiments, the customized follow-up survey system 102 generates survey reports to include data on individual follow-up questions. In some embodiments, the customized follow-up survey system 102 generates survey reports including indications of what survey data is collected based on follow-up questions. FIG. 5 illustrates an administrator device 502 presenting a survey report graphical user interface 504 that includes customized follow-up survey inquiry data for the survey inquiry 402 “Q3: Please outline three areas where you feel that [Name] can improve.” In one or more embodiments, the customized follow-up survey system 102 can generate various survey reports corresponding to various survey inquiries.

The customized follow-up survey system 102 generates the survey report graphical user interface 504 to include a survey response column 506 and a customized follow-up survey inquiry column 508. The customized follow-up survey system 102 organizes the survey responses and their corresponding customized follow-up survey inquiries in utilizing these columns. For example, as shown in FIG. 5, the customized follow-up survey system 102 generates the survey response column 506 to include the survey response “George needs to work on his emotional intelligence, leadership, and communication skills” in row 01. Further, the customized follow-up survey system 102 generates the customized follow-up survey inquiry column 508 to include “N/A” at row 01, indicating that no customized follow-up survey inquiry was asked to receive the corresponding survey response.

Further, as shown in FIG. 5, the customized follow-up survey system 102 generates the survey response column 506 to include the survey response “George needs to work on his communication, delivering on time, and understanding the business values” in row 02. Further, the customized follow-up survey system 102 generates the customized follow-up survey inquiry column 508 to include “Thank you for sharing your thoughts on two areas where George can improve. Can you please suggest one more area where you believe he could make further progress?” at row 02. Thus, the customized follow-up survey system 102 can report what customized follow-up survey inquiries, if any, prompted the reported survey responses.

Further, in one or more embodiments, the customized follow-up survey system 102 can receive user input at the customized follow-up survey inquiry column 508 indicating adjustments to one or more survey follow-up parameters. For example, the customized follow-up survey system 102 can receive user input approving or disapproving of a customized follow-up survey inquiry. Based on this user input, the customized follow-up survey system 102 can prioritize or deprioritize similar customized follow-up survey inquiries. In another example, the customized follow-up survey system 102 can provide a text input element in response to administrator selection of a customized follow-up survey inquiry in the customized follow-up survey inquiry column 508. Further, the customized follow-up survey system 102 can receive and implement additional parameter instructions via this text input element. For example, the customized follow-up survey system 102 can receive an instruction to “Stop thanking the respondent for the incomplete response,” and the customized follow-up survey system 102 can adjust the phrasing of future customized follow-up survey inquiries accordingly. In one or more embodiments, the customized follow-up survey system 102 implements these additional instructions by providing the additional instructions to the multimodal model (e.g., in a customized prompt) that generates the customized follow-up survey inquiries or by modifying training data for the multimodal model (e.g., adding additional training samples) to finetune the multimodal model.

Additionally, in one or more embodiments, the customized follow-up survey system 102 can utilize the multimodal model to generate an explanation of why it generated and provided a customized follow-up survey inquiry. For example, the customized follow-up survey system 102 can provide this explanation to a client device of an administrator of a survey. In one or more embodiments, the customized follow-up survey system 102 provides such explanations alongside a corresponding customized follow-up survey inquiry for review by the administrator of the survey. In one or more embodiments, the customized follow-up survey system 102 generates and provides an explanation for a case in which the customized follow-up survey system 102 decides not to generate/provide a customized follow-up survey inquiry.

As mentioned above, in one or more embodiments, the customized follow-up survey system 102 implements survey parameters received during survey creation. FIG. 6 illustrates an administrator device 602 providing a survey creation graphical user interface 604. More specifically, the customized follow-up survey system 102 generates the survey creation graphical user interface 604 including a survey inquiry panel 606 and a customized follow-up survey inquiry panel 608.

As shown in FIG. 6, the survey inquiry panel 606 includes a survey title reading “Hotel Stay Satisfaction.” Additionally, the survey inquiry panel 606 includes survey inquiries reading “1. How was the cleanliness of the room,” “2. How was the friendliness of the staff?” and “3. Please let us know what needs improvement.” However, the customized follow-up survey system 102 can generate the survey creation graphical user interface 604 including a variety of survey inquiries, answer formatting, and other survey details based on received administrator input.

In one or more embodiments, the customized follow-up survey system 102 receives natural language prompts from an administrator device that define survey response quality classifications. More specifically, in one or more embodiments, the customized follow-up survey system 102 can receive natural language prompts that define triggers for customized follow-up survey inquiries during administration of the digital survey. As shown in FIG. 6, the customized follow-up survey system 102 generates the customized follow-up survey inquiry panel 608 including a topic trigger classification section 610, an instruction trigger classification section 614, and an override trigger classification section 618.

As shown in FIG. 6, the topic trigger classification section 610 is titled “Topic Triggers.” Further, the topic trigger classification section 610 includes bullet points indicating prior user input for keywords, subject matter, or topics. Thus, the customized follow-up survey system 102 can generate survey follow-up parameters indicating keywords or topics that, if included in survey response data, indicate that the customized follow-up survey system 102 should generate a customized follow-up survey inquiry. As shown, the topic trigger classification section 610 includes topic triggers for “Breakfast,” “Linens,” and “Late Check-In.”

As also shown in FIG. 6, the customized follow-up survey system 102 generates the instruction trigger classification section 614 to include previously received instructions indicating goals for the digital survey. As shown, the instruction trigger classification section 614 is titled “Goals.” Also, the instruction trigger classification section 614 includes instructions to “Request to complete,” and, “Prompt additional information for negative sentiment responses about housekeeping.”

As also shown in FIG. 6, the customized follow-up survey system 102 generates the override trigger classification section 618 to include previously received instructions indicating topics to trigger exclusion from consideration for a customized follow-up survey inquiry. As shown, the override trigger classification section 618 is titled “Exclude.” Also, the override trigger classification section 618 includes instructions to exclude customized follow-up survey inquiries for any survey response data indicating “More than one follow-up for the same topic,” and “Hot water.”

In one or more embodiments, the customized follow-up survey system 102 can also receive user input via the survey creation graphical user interface 604 indicating one or more other actions to take in response to survey response content. To illustrate, the customized follow-up survey system 102 can receive and implement a survey parameter requesting a notification to the administrator device 602 or to a client device based on determining a particular survey response quality classification. For example, the customized follow-up survey system 102 can generate a parameter to send a notification to the administrator device 602 in response to receiving a survey response mentioning flooding or a break-in. In another example, the customized follow-up survey system 102 can provide a notification from a booking system to rebook a flight in response to receiving a survey response mentioning needing to rebook a flight.

Additionally, the customized follow-up survey system 102 generates the customized follow-up survey inquiry panel 608 including parameter input boxes 612, 616, 620 corresponding to each of the topic trigger classification section 610, the instruction trigger classification section 614, and the override trigger classification section 618. In one or more embodiments, in response to receiving user input indicating a parameter at the parameter input boxes 612, 616, 620, the customized follow-up survey system 102 adds the parameter to the corresponding section. In one or more embodiments, the customized follow-up survey system 102 receives and utilizes natural language input as the parameters. In addition, or in the alternative, the customized follow-up survey system 102 receives natural language input as search terms for a repository of potential follow-up survey parameters.

Further, the customized follow-up survey system 102 can provide these follow-up survey parameters to a multimodal model to instruct or train the model. To illustrate, in one or more embodiments, the customized follow-up survey system 102 can provide the follow-up survey parameters as natural language instructions to the natural language model by generating an instruction from a template corresponding to the type of survey quality classification. For example, for the “breakfast” topic trigger, the customized follow-up survey system 102 can generate an instruction “Generate a customized follow-up survey inquiry asking for more information when the survey respondent mentions breakfast.” In another example, for the “request completion” goal, the customized follow-up survey inquiry can generate an instruction “Generate a customized follow-up survey inquiry requesting that the respondent answer each part of a survey inquiry if a survey response is incomplete. For an additional example, for the “hot water” exclusion survey response quality classification, the customized follow-up survey system 102 can generate the instruction “Do not generate a customized follow-up survey inquiry for survey responses that mention hot water.” The customized follow-up survey system 102 can, accordingly, generate and provide a variety of instructions for a variety of custom survey follow-up parameters based on various user input.

Additionally, in one or more embodiments, the customized follow-up survey system 102 can utilize a template that specifies a priority order for follow-up topics. Thus, the customized follow-up survey system 102 can follow-up on the most important topics, especially when other survey follow-up parameters limit a quantity of customized follow-up survey inquiries. For example, the customized follow-up survey system 102 can receive and implement a priority order for an airline indicating “1. Safety issues observed; 2. Staff concerns; 3. Seat and plan comfort issues; 4. Food taste complaints.”

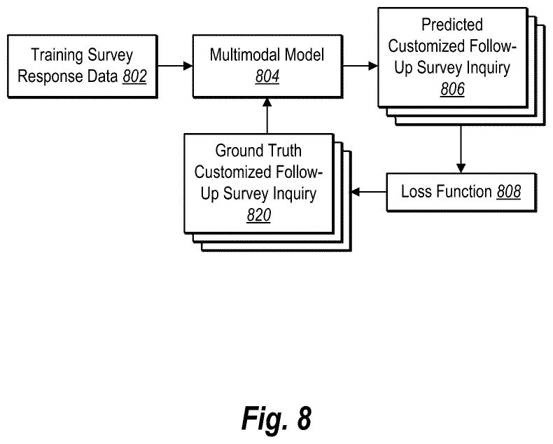

As will be discussed in greater detail below with regard to FIG. 8, the customized follow-up survey system 102 can train a multimodal model to generate customized follow-up survey inquiries. In one or more embodiments, the customized follow-up survey system 102 can generate the ground truth data for such training based on received survey follow-up parameters. Accordingly, in one or more embodiments, the customized follow-up survey system 102 trains a custom multimodal model to generate customized follow-up survey inquiries for a particular survey. In addition, in one or more embodiments, the customized follow-up survey system 102 can utilize a multimodal model or a large language model to generate the ground-truth data. Accordingly, in some embodiments, the customized follow-up survey system 102 can train the multimodal model based on synthetic customized follow-up survey inquiry data.

Additionally, in one or more embodiments, the customized follow-up survey system 102 can receive user-generated follow-ups via the survey creation graphical user interface. In some embodiments, the customized follow-up survey system 102 can receive automatic follow-up inquiries via either the survey inquiry panel 606 and/or the customized follow-up survey inquiry panel 608. To illustrate, the customized follow-up survey system 102 can receive user input indicating optional questions in the survey inquiry panel 606. In this example, the customized follow-up survey system 102 can further receive user input generating parameters under which to provide the optional questions via the customized follow-up survey inquiry panel 608.

In another example, the customized follow-up survey system 102 can receive an instruction via the customized follow-up survey inquiry panel 608 indicating both a user-generated follow-up survey inquiry and parameters for providing the follow-up survey inquiry. For example, the customized follow-up survey system 102 can receive and implement the instruction “If the survey response mentions a lack of options at breakfast, ask the respondent a free response question ‘What options would you most like to have seen at the breakfast?’”

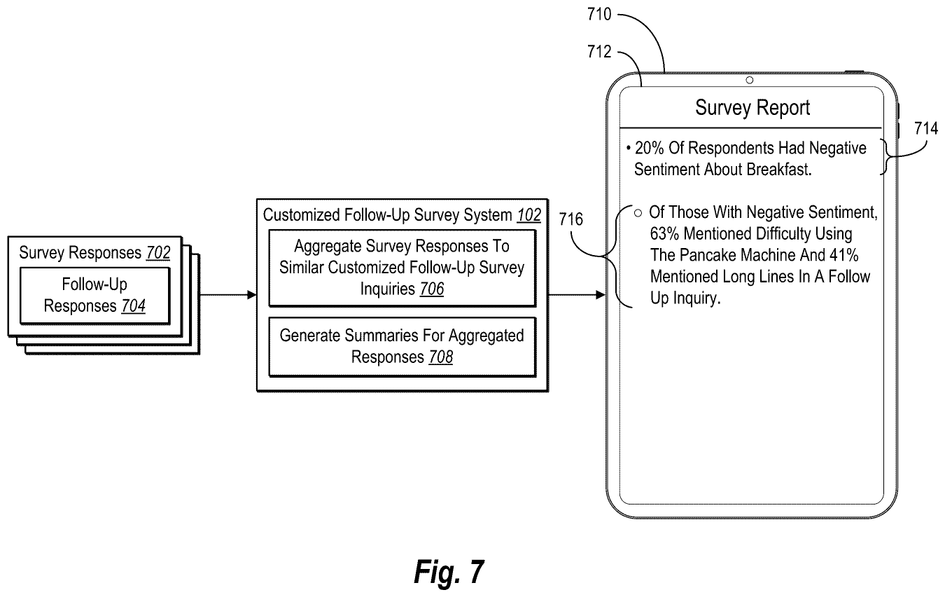

As mentioned above, in one or more embodiments, the customized follow-up survey system 102 generates survey reports by aggregating survey data from similar customized follow-up survey inquiries. FIG. 7 illustrates a process for generating such a survey report. More specifically, as shown in FIG. 7, the customized follow-up survey system 102 receives survey responses 702 and corresponding survey response data, including follow-up responses 704 and their corresponding follow-up survey response data.

As shown in FIG. 7, the customized follow-up survey system 102 performs an act 706 of aggregating survey responses to similar customized follow-up survey inquiries. In one or more embodiments, the customized follow-up survey system 102 aggregates all survey responses that had the same survey response quality classification and/or the same trigger to generate the customized follow-up survey inquiry. Thus, the customized follow-up survey system 102 can aggregate follow-up survey responses that are related to the same goal, topic, or other trigger. In addition, or in the alternative, the customized follow-up survey system 102 can sort follow-up survey responses using a decision tree, keyword analysis, or another algorithm.

As also shown in FIG. 7, the customized follow-up survey system 102 performs an act 708 of generating summaries for aggregated responses. More specifically, in one or more embodiments, the customized follow-up survey system 102 summarizes each group of sorted follow-up responses. To illustrate, in one or more embodiments, the customized follow-up survey system 102 provides the similar responses to a multimodal model and receives a summary of the group of responses. In addition, or in the alternative, the customized follow-up survey system 102 can utilize other algorithms to generate sentiment scores, identify key words, or perform other natural language analysis.

In one or more embodiments, the customized follow-up survey system 102 utilizes the multimodal model or another machine learning model to identify trends among responses. In some embodiments, the customized follow-up survey system 102 further utilizes the multimodal model or another machine learning model to identify quantitative data for these trends. The customized follow-up survey system 102 can also determine quantitative data for similar responses generally, such as what percentage of all survey responses fall into a given category, what percentage of responses with a trigger classification have a particular sentiment, or information on overlap between trigger classifications. For example, the customized follow-up survey system 102 can determine and report “15% of respondents mentioned the pool,” “Of responses that mentioned the front desk, 82% were positive,” or “35% of respondents who had very positive responses mentioned housekeeping.”

Additionally, in one or more embodiments, the customized follow-up survey system 102 can utilize the multimodal model to identify trends in the survey response data. To illustrate, the customized follow-up survey system 102 can utilize the multimodal model to generate a summary particular to new information, or types of survey responses not previously seen. For example, the customized follow-up survey system 102 can utilize the multimodal model to identify a significant increase in survey responses mentioning air conditioning relative to the previous week, and generate a survey report including the text “This week, there are 73% more negative responses indicating that the air conditioning doesn't work or that the restaurant is too hot.”

To illustrate, as shown in FIG. 7, the customized follow-up survey system 102 can generate and provide a survey report graphical user interface 712 via an administrator device 710. As shown in FIG. 7, the customized follow-up survey system 102 generates the survey report graphical user interface 712 to include a subheading 714 that reads “20% of respondents had negative sentiment about breakfast.” In one or more embodiments, the customized follow-up survey system 102 can generate subheadings for various groups of similar follow-up survey responses. In some embodiments, the customized follow-up survey system 102 generates a subheading in a survey report for each survey response quality classification.

Further, as shown in FIG. 7, the customized follow-up survey system 102 includes a summary section 716. More specifically, the summary section 716 reads “Of those with negative sentiment, 63% mentioned difficulty using the pancake machine and 41% mentioned long lines in a follow-up inquiry.” In one or more embodiments, the customized follow-up survey system 102 generates and organizes survey reports to provide summaries for each group of responses to similar customized follow-up survey inquiries. Accordingly, the customized follow-up survey system 102 can generate the survey report graphical user interface 712 including a variety of summaries based on various survey response data. In some embodiments, the customized follow-up survey system 102 can provide these summaries in a list, in prose, using charts and graphs, or other data reporting methods.

Additionally, in one or more embodiments, the customized follow-up survey system 102 can generate and provide information about survey retention, including as related to customized follow-up survey inquiries. To illustrate, the customized follow-up survey system 102 can utilize the multimodal model to determine types of customized follow-up survey inquiries, topics of customized follow-up survey inquiries, and/or quantities of customized follow-up survey inquiries that lead to non-completion of a digital survey. Further, the customized follow-up survey system 102 can provide this information in a digital survey report, and can include a prompt to adjust one or more relevant survey parameters. In addition, or in the alternative, the customized follow-up survey system 102 can provide this data to the multimodal model for further model training, as will be discussed below with regard to FIG. 8.

Further, in one or more embodiments, the customized follow-up survey system 102 navigates to additional survey report graphical user interfaces upon detecting user selection of the summary section 716. To illustrate, the customized follow-up survey system 102 can provide additional detail regarding survey responses in the category relevant to the summary section 716. For example, in one or more embodiments, in response to receiving user selection of the summary section 716, the customized follow-up survey system 102 provides a graphical user interface including specific customized follow-up survey inquiries and corresponding responses, similar to the survey report graphical user interface 504 discussed above with regard to FIG. 5.

Additionally, in one or more embodiments, the customized follow-up survey system 102 can generate a summary that synthesizes/combines one or more survey responses into a single survey response. For example, the customized follow-up survey system 102 can combine similar survey responses from different survey respondents to generate a synthetic response that mimics a real response. To illustrate, the customized follow-up survey system 102 can mimic how a respondent likely would have responded if they had provided all of the required/requested information in an initial response (e.g., for a case in which a follow-up inquiry would not be needed). In addition, in one or more embodiments, the customized follow-up survey system 102 can combine responses from a chain of customized follow-up survey inquiries into a single response for a survey report.

As mentioned above, in one or more embodiments the customized follow-up survey system 102 trains a multimodal model to generate customized follow-up survey inquiries. FIG. 8 illustrates a process for training a multimodal model. In particular, as shown in FIG. 8, the customized follow-up survey system 102 can provide training survey response data 802 to a multimodal model 804.

Additionally, as shown in FIG. 8, the multimodal model 804 determines predicted customized follow-up survey inquiries 806 based on the training survey response data 802. Subsequently, the multimodal model 804 compares the predicted customized follow-up survey inquiries 806 to ground truth customized follow-up survey inquiries 820 utilizing a loss function 808 to determine a loss. Further, the customized follow-up survey system 102 can update parameters of the multimodal model 804 to improve subsequent predictions.

In one or more embodiments, the loss function 808 can include a cross-entropy loss, a regression loss function (e.g., a mean square error function, a quadratic loss function, an L2 loss function, a mean absolute error/L1 loss function, mean bias error, etc.). Additionally, or alternatively, the loss function 808 can include a classification loss function (e.g., a hinge loss/multi-class SVM loss function, cross entropy loss/negative log likelihood function, etc.). In certain instances, the loss function 808 includes the Gini Index. Further, the loss function 808 can return loss values comprising quantifiable data regarding the difference between the customized follow-up survey inquiries 806 and the ground truth customized follow-up survey inquiries 820. In particular, the customized follow-up survey system 102 can adjust various parameters/weights of the multimodal model 804 to improve the quality/accuracy of the multimodal model 804.

As suggested by FIG. 8, the training/learning of the multimodal model 804 can be an iterative process. Indeed, the customized follow-up survey system 102 can continually adjust parameters and/or hyperparameters of the multimodal model 804 over learning cycles, as shown by the return arrow between the loss function 808 and the multimodal model 804. By incrementally adjusting parameters of the multimodal model 804 until satisfying a convergence threshold, the customized follow-up survey system 102 improves the predicted customized follow-up survey inquiries over training iterations. Further, in one or more embodiments, the customized follow-up survey system 102 continually trains the multimodal model 804 utilizing updated survey responses, including those corresponding to updated survey inquiries. Accordingly, the customized follow-up survey system 102 can adjust the multimodal model 804 in real-time to respond to more up-to-date information and trends.

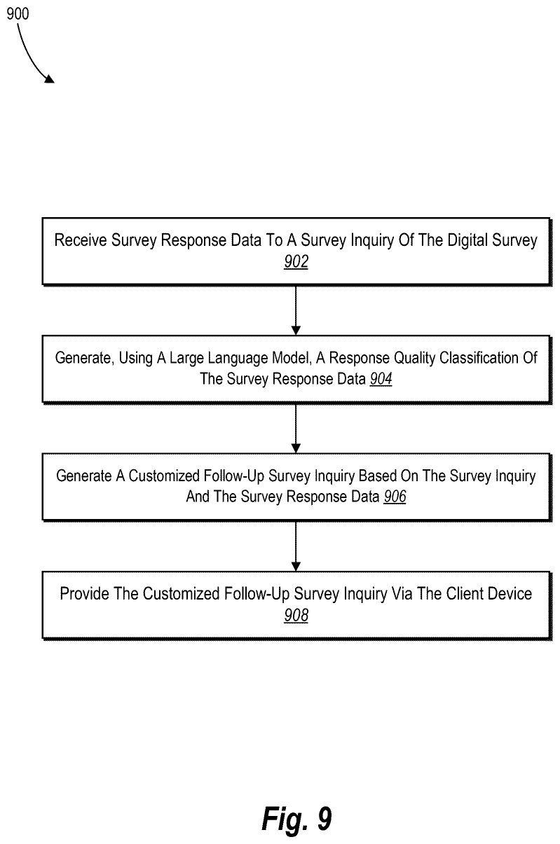

FIGS. 1-8, the corresponding text, and the examples provide a number of different methods, systems, devices, and non-transitory computer-readable media of the customized follow-up survey system 102. In addition to the foregoing, one or more embodiments can also be described in terms of flowcharts comprising acts for accomplishing a particular result, as shown in FIG. 9. FIG. 9 may be performed with more or fewer acts. Further, the acts may be performed in differing orders. Additionally, the acts described herein may be repeated or performed in parallel with one another or parallel with different instances of the same or similar acts.

As mentioned, FIG. 9 illustrates a flowchart of a series of acts 900 for generating and providing a customized follow-up survey inquiry in accordance with one or more embodiments. While FIG. 9 illustrates acts according to one embodiment, alternative embodiments may omit, add to, reorder, and/or modify any of the acts shown in FIG. 9. The acts of FIG. 9 can be performed as part of a method. Alternatively, a non-transitory computer-readable medium can comprise instructions that, when executed by one or more processors, cause a computing device to perform the acts of FIG. 9. In some embodiments, a system can perform the acts of FIG. 9.

As shown in FIG. 9, the series of acts 900 includes an act 902 for receiving survey response data to a survey inquiry of the digital survey. In particular, the act 902 can include receiving, from a respondent client device during administration of a digital survey, survey response data to a survey inquiry of the digital survey.

Additionally, as shown in FIG. 9, the series of acts 900 includes an act 904 for generating, using a multimodal model, a response quality classification of the survey response data. In particular, the act 904 can include generating, by providing a prompt comprising the survey response data to a multimodal model, a response quality classification of the survey response data.

Further, as shown in FIG. 9, the series of acts 900 includes an act 906 for generating a customized follow-up survey inquiry based on the survey inquiry and the survey response data. In particular, the act 906 can include in response to generating the response quality classification, generate a customized follow-up survey inquiry based on the survey inquiry and the survey response data.

As also shown by FIG. 9, the series of acts 900 includes an act 908 for providing the customized follow-up survey inquiry. In particular, the act 908 can include provide, during the administration of the digital survey, the customized follow-up survey inquiry via the respondent client device.

Additionally, the series of acts 900 can include generating the customized follow-up survey inquiry in response to determining that the response quality classification of the survey response data indicates a trigger to generate the customized follow-up survey inquiry. Further, the series of acts 900 can include determining, from an administrator device during creation of the digital survey, one or more natural language prompts defining one or more triggers for customized follow-up survey inquiries based on response quality classifications, and providing the one or more natural language prompts defining the one or more triggers based on the response quality classifications to the multimodal model during creation of the digital survey.

The series of acts 900 can also include generating the response quality classification based on response quality classifications comprising a categorization of completeness, actionability, sentiment, or subject matter according to the one or more triggers for customized follow-up survey inquiries. Additionally, the series of acts 900 can include generating the response quality classification based on determining that the survey response data does not include an excluded category according to the one or more triggers for customized follow-up survey inquiries.

Additionally, the series of acts 900 can include generate the response quality classification of the survey response data by providing a prompt comprising the survey response data to the multimodal model, receiving, from the multimodal model, a follow-up score, and utilizing the follow-up score to generate the response quality classification of the survey response data. Further, the series of acts 900 can include utilizing the follow-up score to generate the response quality classification by determining, from the follow-up score a number of triggers indicated by the survey response and a degree to which the survey response indicates the number of triggers.

The series of acts 900 can also include receiving a follow-up response to the customized follow-up survey inquiry via the respondent client device, determining a summary for the follow-up response and one or more follow-up responses to one or more additional follow-up survey inquiries, and generating a survey report comprising the summary for the follow-up response and one or more follow-up responses to the one or more additional follow-up survey inquiries. Additionally, the series of acts 900 can include iteratively training the multimodal model by predicting customized follow-up survey inquiries for a training set of survey response data, and modifying the multimodal model based on comparing the predicted customized follow-up survey inquiries with ground truth customized follow-up survey inquiries to reduce or minimize a loss of a loss function.

Embodiments of the present disclosure may comprise or utilize a special-purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In one or more embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural marketing features and/or methodological acts, it is to be understood that the subject matter defined in the appended claims is not necessarily limited to the described marketing features or acts described above. Rather, the described marketing features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, touch-screen kiosks, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing subscription model can be composed of various characteristics such as, for example, on-demand self-service, broad network access, resource pooling, rapid elasticity, measured service, and so forth. A cloud-computing subscription model can also expose various service subscription models, such as, for example, Software as a Service (“SaaS”), a web service, Platform as a Service (“PaaS”), and Infrastructure as a Service (“IaaS”). A cloud-computing subscription model can also be deployed using different deployment subscription models such as private cloud, community cloud, public cloud, hybrid cloud, and so forth. In this description and in the claims, a “cloud-computing environment” is an environment in which cloud computing is employed.

FIG. 10 illustrates a block diagram of an exemplary computing device 1000 that may be configured to perform one or more of the processes described above. One will appreciate that one or more computing devices such as the computing device 1000 may implement the devices described above in connection with FIG. 1. As shown by FIG. 10, the computing device 1000 can comprise a processor 1002, a memory 1004, a storage device 1006, an I/O interface 1008, and a communication interface 1010, which may be communicatively coupled by way of a communication infrastructure 1012. While the exemplary computing device 1000 is shown in FIG. 10, the components illustrated in FIG. 10 are not intended to be limiting. Additional or alternative components may be used in other embodiments. Furthermore, in certain embodiments, the computing device 1000 can include fewer components than those shown in FIG. 10. Components of the computing device 1000 shown in FIG. 10 will now be described in additional detail.

In one or more embodiments, the processor 1002 includes hardware for executing instructions, such as those making up a computer program. As an example, and not by way of limitation, to execute instructions, the processor 1002 may retrieve (or fetch) the instructions from an internal register, an internal cache, the memory 1004, or the storage device 1006 and decode and execute them. In one or more embodiments, the processor 1002 may include one or more internal caches for data, instructions, or addresses. As an example, and not by way of limitation, the processor 1002 may include one or more instruction caches, one or more data caches, and one or more translation lookaside buffers (“TLBs”). Instructions in the instruction caches may be copies of instructions in the memory 1004 or the storage device 1006.

The memory 1004 may be used for storing data, metadata, and programs for execution by the processor(s). The memory 1004 may include one or more of volatile and non-volatile memories, such as Random-Access Memory (“RAM”), Read Only Memory (“ROM”), a solid-state disk (“SSD”), Flash, Phase Change Memory (“PCM”), or other types of data storage. The memory 1004 may be internal or distributed memory.

The storage device 1006 includes storage for storing data or instructions. As an example, and not by way of limitation, storage device 1006 can comprise a non-transitory storage medium described above. The storage device 1006 may include a hard disk drive (“HDD”), a floppy disk drive, flash memory, an optical disc, a magneto-optical disc, magnetic tape, or a Universal Serial Bus (“USB”) drive or a combination of two or more of these. The storage device 1006 may include removable or non-removable (or fixed) media, where appropriate. The storage device 1006 may be internal or external to the computing device 1000. In one or more embodiments, the storage device 1006 is non-volatile, solid-state memory. In other embodiments, the storage device 1006 includes read-only memory (“ROM”). Where appropriate, this ROM may be mask programmed ROM, programmable ROM (“PROM”), erasable PROM (“EPROM”), electrically erasable PROM (“EEPROM”), electrically alterable ROM (“EAROM”), or flash memory or a combination of two or more of these.

The I/O interface 1008 allows a user to provide input to, receive output from, and otherwise transfer data to and receive data from the computing device 1000. The I/O interface 1008 may include a mouse, a keypad or a keyboard, a touch screen, a camera, an optical scanner, network interface, modem, other known I/O devices or a combination of such I/O interfaces. The I/O interface 1008 may include one or more devices for presenting output to a user, including, but not limited to, a graphics engine, a display (e.g., a display screen), one or more output drivers (e.g., display drivers), one or more audio speakers, and one or more audio drivers. In certain embodiments, the I/O interface 1008 is configured to provide graphical data to a display for presentation to a user. The graphical data may be representative of one or more graphical user interfaces and/or any other graphical content as may serve a particular implementation.

The communication interface 1010 can include hardware, software, or both. In any event, the communication interface 1010 can provide one or more interfaces for communication (such as, for example, packet-based communication) between the computing device 1000 and one or more other computing devices or networks. As an example and not by way of limitation, the communication interface 1010 may include a network interface controller (“NIC”) or network adapter for communicating with an Ethernet or other wire-based network or a wireless NIC (“WNIC”) or wireless adapter for communicating with a wireless network, such as a WI-FI.

Additionally, or alternatively, the communication interface 1010 may facilitate communications with an ad hoc network, a personal area network (“PAN”), a local area network (“LAN”), a wide area network (“WAN”), a metropolitan area network (“MAN”), or one or more portions of the Internet or a combination of two or more of these. One or more portions of one or more of these networks may be wired or wireless. As an example, the communication interface 1010 may facilitate communications with a wireless PAN (“WPAN”) (such as, for example, a BLUETOOTH WPAN), a WI-FI network, a WI-MAX network, a cellular telephone network (such as, for example, a Global System for Mobile Communications (“GSM”) network), or other suitable wireless network or a combination thereof.

Additionally, the communication interface 1010 may facilitate communications various communication protocols. Examples of communication protocols that may be used include, but are not limited to, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), User Datagram Protocol (“UDP”), Global System for Mobile Communications (“GSM”) technologies, Code Division Multiple Access (“CDMA”) technologies, Time Division Multiple Access (“TDMA”) technologies, Short Message Service (“SMS”), Multimedia Message Service (“MMS”), radio frequency (“RF”) signaling technologies, Long Term Evolution (“LTE”) technologies, wireless communication technologies, in-band and out-of-band signaling technologies, and other suitable communications networks and technologies.

The communication infrastructure 1012 may include hardware, software, or both that couples components of the computing device 1000 to each other. As an example and not by way of limitation, the communication infrastructure 1012 may include an Accelerated Graphics Port (“AGP”) or other graphics bus, an Enhanced Industry Standard Architecture (“EISA”) bus, a front-side bus (“FSB”), a HYPERTRANSPORT (“HT”) interconnect, an Industry Standard Architecture (“ISA”) bus, an INFINIBAND interconnect, a low-pin-count (“LPC”) bus, a memory bus, a Micro Channel Architecture (“MCA”) bus, a Peripheral Component Interconnect (“PCI”) bus, a PCI-Express (“PCIe”) bus, a serial advanced technology attachment (“SATA”) bus, a Video Electronics Standards Association local (“VLB”) bus, or another suitable bus or a combination thereof.

FIG. 11 illustrates an example network environment 1100. Network environment 1100 includes a client system 1108, and a digital survey management system 1104 connected to each other by a network 1106. Although FIG. 11 illustrates a particular arrangement of client system 1108, digital content survey system 1104, and network 1106, this disclosure contemplates any suitable arrangement of client system 1108, digital content survey system 1104, and network 1106. As an example and not by way of limitation, two or more of client system 1108, and digital survey management system 1104 can be connected to each other directly, bypassing network 1106. As another example, two or more of client system 1108 and digital survey management system 1104 can be physically or logically co-located with each other in whole, or in part. Moreover, although FIG. 11 illustrates a particular number of client systems 1108, digital content survey system 1104, and network 1106, this disclosure contemplates any suitable number of client systems 1108, digital content survey system 1104, and network 1106. As an example and not by way of limitation, network environment 1100 can include multiple client systems 1108, digital content survey system 1104, and network 1106.

This disclosure contemplates any suitable network 1106. As an example and not by way of limitation, one or more portions of network 1106 can include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 1106 can include one or more networks.

Links can connect client system 1108, and digital survey management system 1104 to network 1106 or to each other. This disclosure contemplates any suitable links. In particular embodiments, one or more links include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links. Links need not necessarily be the same throughout network environment 1100. One or more first links can differ in one or more respects from one or more second links.

In particular embodiments, client system 1108 can be an electronic device including hardware, software, or embedded logic components or a combination of two or more such components and capable of carrying out the appropriate functionalities implemented or supported by client system 1108. As an example and not by way of limitation, a client system 1108 can include any of the computing devices discussed above in relation to FIG. 11. A client system 1108 can enable a network user at client system 1108 to access network 1106. A client system 1108 can enable its user to communicate with other users at other client devices or systems.

In particular embodiments, client system 1108 can include a web browser, such as MICROSOFT EDGE, GOOGLE CHROME, or MOZILLA FIREFOX, and can have one or more add-ons, plug-ins, or other extensions, such as TOOLBAR or YAHOO TOOLBAR. A user at client system 1108 can enter a Uniform Resource Locator (URL) or other address directing the web browser to a particular server (such as server, or a server associated with a third-party system), and the web browser can generate a Hypertext Transfer Protocol (HTTP) request and communicate the HTTP request to server. The server can accept the HTTP request and communicate to client system 1108 one or more Hypertext Markup Language (HTML) files responsive to the HTTP request. Client system 1108 can render a webpage based on the HTML files from the server for presentation to the user. This disclosure contemplates any suitable webpage files. As an example and not by way of limitation, webpages can render from HTML files, Extensible Hypertext Markup Language (XHTML) files, or Extensible Markup Language (XML) files, according to particular needs. Such pages can also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser can use to render the webpage) and vice versa, where appropriate.

In particular embodiments, digital survey management system 1104 can include a variety of servers, sub-systems, programs, modules, logs, and data stores. In particular embodiments, digital survey management system 1104 can include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. Digital survey management system 1104 can also include suitable components such as network interfaces, security mechanisms, load balancers, failover servers, management-and-network-operations consoles, other suitable components, or any suitable combination thereof.

In particular embodiments, digital survey management system 1104 can include one or more user-profile stores for storing user profiles. A user profile can include, for example, biographic information, demographic information, behavioral information, social information, or other types of descriptive information, such as work experience, educational history, hobbies or preferences, interests, affinities, or location. Interest information can include interests related to one or more categories. Categories can be general or specific.

The foregoing specification is described with reference to specific exemplary embodiments thereof. Various embodiments and aspects of the disclosure are described with reference to details discussed herein, and the accompanying drawings illustrate the various embodiments. The description above and drawings are illustrative and are not to be construed as limiting. Numerous specific details are described to provide a thorough understanding of various embodiments.

The additional or alternative embodiments can be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A system comprising:
at least one processor; and
at least one non-transitory computer-readable storage medium storing instructions that, when executed by the at least one processor, cause the system to:
receive, from a respondent client device during administration of a digital survey, survey response data to a survey inquiry of the digital survey;
generate, by providing a prompt comprising the survey response data to a multimodal model, a response quality classification of the survey response data;
in response to generating the response quality classification, generate a customized follow-up survey inquiry based on the survey inquiry and the survey response data; and
provide, during the administration of the digital survey, the customized follow-up survey inquiry via the respondent client device.

2. The system of claim 1, further comprising instructions that, when executed by the at least one processor, cause the system to generate the customized follow-up survey inquiry in response to determining that the response quality classification of the survey response data indicates a trigger to generate the customized follow-up survey inquiry.

3. The system of claim 2, further comprising instructions that, when executed by the at least one processor, cause the system to:
determine, from an administrator device during creation of the digital survey, one or more natural language prompts defining one or more triggers for customized follow-up survey inquiries based on response quality classifications; and
provide the one or more natural language prompts defining the one or more triggers based on the response quality classifications to the multimodal model during creation of the digital survey and survey respondent data.

4. The system of claim 3, further comprising instructions that, when executed by the at least one processor, cause the system to generate the response quality classification based on response quality classifications comprising a categorization of completeness, actionability, sentiment, or subject matter according to the one or more triggers for customized follow-up survey inquiries.

5. The system of claim 3, further comprising instructions that, when executed by the at least one processor, cause the system to generate the response quality classification based on determining that the survey response data does not include an excluded category according to the one or more triggers for customized follow-up survey inquiries.

6. The system of claim 1, further comprising instructions that, when executed by the at least one processor, cause the system to generate the response quality classification of the survey response data by:
providing a prompt comprising the survey response data to the multimodal model;
receiving, from the multimodal model, a follow-up score; and
utilizing the follow-up score to generate the response quality classification of the survey response data.

7. The system of claim 6, wherein utilizing the follow-up score to generate the response quality classification comprises determining, from the follow-up score, a number of triggers indicated by the survey response data and a degree to which the survey response data indicates the number of triggers.

8. The system of claim 1, further comprising instructions that, when executed by the at least one processor, cause the system to:
receive a follow-up response to the customized follow-up survey inquiry via the respondent client device;
determine a summary for the follow-up response and one or more follow-up responses to one or more additional follow-up survey inquiries; and
generate a survey report comprising the summary for the follow-up response and one or more follow-up responses to the one or more additional follow-up survey inquiries.

9. The system of claim 1, further comprising instructions that, when executed by the at least one processor, cause the system to iteratively train the multimodal model by:
predicting customized follow-up survey inquiries for a training set of survey response data; and
modifying the multimodal model based on comparing the predicted customized follow-up survey inquiries with ground truth customized follow-up survey inquiries to reduce or minimize a loss of a loss function.

10. A non-transitory computer-readable medium storing instructions that, when executed by at least one processor, cause a computer device to:
receive, from a respondent client device during administration of a digital survey, survey response data to a survey inquiry of the digital survey;
generate, by providing a prompt comprising the survey response data to a multimodal model, a response quality classification of the survey response data;
in response to generating the response quality classification, generate a customized follow-up survey inquiry based on the survey inquiry and the survey response data; and
provide, during the administration of the digital survey, the customized follow-up survey inquiry via the respondent client device.

11. The non-transitory computer-readable medium of claim 10, further comprising instructions that, when executed by the at least one processor, cause the computer device to generate the customized follow-up survey inquiry in response to determining that the response quality classification of the survey response data indicates a trigger to generate the customized follow-up survey inquiry.

12. The non-transitory computer-readable medium of claim 11, further comprising instructions that, when executed by the at least one processor, cause the computer device to:
determine, from an administrator device during creation of the digital survey, one or more natural language prompts defining one or more triggers for customized follow-up survey inquiries based on response quality classifications; and
provide the one or more natural language prompts defining the one or more triggers based on the response quality classifications to the multimodal model during creation of the digital survey.

13. The non-transitory computer-readable medium of claim 12, further comprising instructions that, when executed by the at least one processor, cause the computer device to generate the response quality classification based on response quality classifications comprising a categorization of completeness, actionability, sentiment, or subject matter according to the one or more triggers for customized follow-up survey inquiries.

14. The non-transitory computer-readable medium of claim 12, further comprising instructions that, when executed by the at least one processor, cause the computer device to generate the response quality classification based on determining that the survey response data does not include an excluded category according to the one or more triggers for customized follow-up survey inquiries.

15. The non-transitory computer-readable medium of claim 10, further comprising instructions that, when executed by the at least one processor, cause the computer device to generate the response quality classification of the survey response data by:
providing a prompt comprising the survey response data to the multimodal model;
receiving, from the multimodal model, a follow-up score; and
utilizing the follow-up score to generate the response quality classification of the survey response data by determining, from the follow-up score, a number of triggers indicated by the survey response data and a degree to which the survey response data indicates the number of triggers.

16. The non-transitory computer-readable medium of claim 10, further comprising instructions that, when executed by the at least one processor, cause the computer device to:
receive a follow-up response to the customized follow-up survey inquiry via the respondent client device;
determine a summary for the follow-up response and one or more follow-up responses to one or more additional follow-up survey inquiries; and
generate a survey report comprising the summary for the follow-up response and one or more follow-up responses to the one or more additional follow-up survey inquiries.

17. The non-transitory computer-readable medium of claim 10, further comprising instructions that, when executed by the at least one processor, cause the computer device to iteratively train the multimodal model by:
predicting customized follow-up survey inquiries for a training set of survey response data; and
modifying the multimodal model based on comparing the predicted customized follow-up survey inquiries with ground truth customized follow-up survey inquiries to reduce or minimize a loss of a loss function.

18. A computerized method comprising:
receiving, from a respondent client device during administration of a digital survey, survey response data to a survey inquiry of the digital survey;
generating, by providing a prompt comprising the survey response data to a multimodal model, a response quality classification of the survey response data;
in response to generating the response quality classification, generating a customized follow-up survey inquiry based on the survey inquiry and the survey response data; and
providing, during the administration of the digital survey, the customized follow-up survey inquiry via the respondent client device.

19. The computerized method of claim 18, further comprising generating the customized follow-up survey inquiry in response to determining that the response quality classification of the survey response data indicates a trigger to generate the customized follow-up survey inquiry.

20. The computerized method of claim 18, further comprising:
determining, from an administrator device during creation of the digital survey, one or more natural language prompts defining one or more triggers for customized follow-up survey inquiries based on response quality classifications; and
providing the one or more natural language prompts defining the one or more triggers based on the response quality classifications to the multimodal model during creation of the digital survey.
